(19) United States
(12) Patent Application Publication
(10) Pub. No.: US 2021/0055731 A1
(43) Pub. Date: Feb. 25, 2021

(54) CLOSED-LOOP MOTION CONTROL METHOD AND SYSTEM FOR A THREE-THRUSTER UNMANNED UNDERWATER VEHICLE

(71) Applicant: SHENZHEN GENEINNO TECHNOLOGY COMPANY LTD, Shenzhen (CN)

(72) Inventors: SHENGWEI WANG, SHENZHEN (CN); JUNPING HUANG, SHENZHEN (CN)

(21) Appl. No.: 17/090,923

(22) Filed: Nov. 6, 2020

Related U.S. Application Data
(63) Continuation of application No. PCT/CN2018/112600, filed on Oct. 30, 2018.

(30) Foreign Application Priority Data
Jun. 7, 2018 (CN) 201810577839.X

(51) Int. Cl. G05D 1/02; B63G 8/00; G05D 1/08; G05D 1/04

(52) U.S. Cl. CPC G05D 1/0206; B63G 8/001; B63G 2008/004; G05D 1/048; G05D 1/0875

(57) ABSTRACT

The disclosure first measures the current information of the underwater situation the unmanned underwater vehicle (UUV) is found in, then calculates the force of the UUV on each degree of freedom (DOF) based on the information. Then the force on each UUV is fused with the respective force output by a command of a terminal to obtain a resultant force on each UUV Further, a thrust distribution matrix is used to distribute the resultant forces to the various thrusters of the UUV to obtain the output forces of the respective thrusters. Finally, the output force of each thruster is fused with the respective output force of the thruster that is output by the command of the terminal to obtain the thrust output required by the thruster.

### CROSS-REFERENCE TO RELATED APPLICATIONS

This application is a continuation of co-pending International Patent Application Number PCT/CN2018/112600, filed on Oct. 30, 2018, which claims the priority of Chinese Patent Application Number 201810577839.X filed on Jun. 7, 2018 with China National Intellectual Property Administration, the disclosures of which are incorporated herein by reference in their entireties.

### TECHNICAL FIELD

This disclosure relates to the technical field of drone control, and more particularly relates to a closed-loop motion control method and system for a three-thruster unmanned underwater vehicle (UUV).

### BACKGROUND

PID (proportional-integral-derivative) motion control technology and algorithm is a control method and strategy based on the concept of feedback to reduce uncertainty. It is currently the most widely used control regulator in engineering practice. PID controller (proportional-integral-derivative controller) is a common feedback loop component used in industrial control applications. It consists of a proportional unit P, an integral unit I, and a derivative unit D. The basis of PID control is proportional control. Integral control can eliminate steady-state errors, but may increase overshoot. Derivative control can increase the responsiveness of large inertia systems and weaken the trend of overshoot.

For three-thruster unmanned underwater vehicles, the current typical control strategies are all concerning closed-loop feedback in the direction of a single degree of freedom (DOF), including the following that are unique to unmanned underwater vehicles. Included are a depth holding PID controller serving the closed-loop control strategy that holds the unmanned underwater vehicle steadily at a specific depth, a direction holding PID controller serving the closed-loop control strategy that maintains the unmanned underwater vehicle to navigate at a specific heading, and an attitude stabilization PID controller serving the closed-loop control strategy that maintains the unmanned underwater vehicle at a stable attitude. At present, for unmanned underwater vehicles with unsaturated degrees of freedom, the depth holding PID controller, the direction holding PID controller, and the attitude stabilization PID controller are generally independent of each other. Motion control is mainly performed by activating 1 or 2 PID controllers depending on specific needs, and the various PID controllers work independently and are not combined as a whole to control all the thrusters. Furthermore, three-thruster unmanned underwater vehicles are generally in a state of unsaturated degrees of freedom, that is, the number of degrees of freedom of the machine body exceeds the number of thrusters, rendering the PID closed-loop control effect not obvious and effective.

### SUMMARY

In view of the above, one main technical problem to be solved by the present disclosure is to provide a closed-loop motion control method for a three-thruster unmanned underwater vehicle, which is aimed at an unmanned underwater vehicle with unsaturated degrees of freedom and can automatically control the body balance and attitude stability based on the real-time attitude feedback of the unmanned underwater vehicle under the state of unsaturated degrees of freedom. Further provided is a closed-loop motion control system for a three-thruster unmanned underwater vehicle.

To solve the above technical problems, a technical solution adopted by the present disclosure is to provide a closed-loop motion control method for a three-thruster unmanned underwater vehicle, which includes the following operations:

operation S1: measuring the current information of the underwater situation the unmanned underwater vehicle is found in;

operation S2: calculating the force of the unmanned underwater vehicle on each degree of freedom based on the information;

operation S3: fusing the force on each degree of freedom calculated in operation S2 with the respective force output by a command of a terminal to obtain the resultant force on each degree of freedom;

operation S4: distributing the resultant forces in operation S3 to various thrusters of the unmanned underwater vehicle based on a thrust distribution matrix, thus obtaining the output force of each thruster; and

operation S5: fusing the output force of each thruster with the respective output force of the thruster output by the command of the terminal to obtain the thrust output required by the thruster.

As an improvement of the present disclosure, further included is operation S6, including limiting the output force of each thruster. In particular, when the output force of the thruster exceeds a set value, the output force of the thruster is determined as the set value.

As a further improvement of the present disclosure, operation S1 includes: measuring a depth variation, a heading angle variation, and a pitch angle variation using a depth holding PID controller, a direction holding PID controller, and a pitch stabilization PID controller, respectively.

As a further improvement of the present disclosure, operation S2 includes: calculating the force F_{z1} along the Z axis, the force N_{z1} around the Z axis, and the force N_{y1} around the Y axis based the depth variation, the heading angle variation, and the pitch angle variation, respectively.

As a further improvement of the present disclosure, operation S3 includes: fusing the force F_{z1} along the Z-axis, the force N_{z1} around the Z-axis, and the force N_{y1} around the Y-axis with the force F_{z2} in the Z-axis, the force N_{z2} around the Z-axis, and the force N_{y2} around the Y-axis that are output by the command issued from the terminal, respectively, so as to obtain three resultant force outputs in the directions of unsaturated degrees of freedom: the resultant force F_{z} along the Z axis, the resultant force N_{z} around the Z axis, and the resultant force N_{y} around the Y-axis.

As a further improvement of the present disclosure, in operation S4, the thrust distribution matrix is used to distribute the resultant force F_{z} along the Z axis, the resultant force N_{z} around the Z axis and the resultant force N_{y} around the Y axis to the vertical thrust F₁, horizontal thrust Fₚ₁, and horizontal thrust Fₛ₁ of the three thrusters, respectively.

As a further improvement of the present disclosure, operation S5 includes: fusing the vertical thrust F₁, the horizontal thrust Fₚ₁, and the horizontal thrust Fₛ₁ with the horizontal thrust Fₚ₂ and the horizontal thrust Fₛ₂ output by the command issued by the terminal to obtain the vertical thrust F, horizontal thrust Fₚ, and horizontal thrust Fₛ of the thrust outputs required by the three thrusters, and further performing thrust output based on the vertical thrust F, the horizontal thrust Fₚ, and the horizontal thrust Fₛ.

As a further improvement of the present disclosure, in operation S5, the vertical thrust F is equal to the vertical thrust F₁, the horizontal thrust Fₚ is equal to the sum of the horizontal thrust Fₚ₁ and the horizontal thrust Fₚ₂, and the horizontal thrust Fₛ is equal to sum of the horizontal thrust Fₛ₁ and the horizontal thrust Fₛ₂.

There is further provided a closed-loop motion control system for a three-thruster unmanned underwater vehicle, including:

an information collection module configured to measure the current information of the situation the unmanned underwater vehicle is found in;

an information processing module configured to calculate the force of the unmanned underwater vehicle on each degree of freedom based on the information;

a fusion module configured to fuse the force on each degree of freedom calculated by the information processing module with the respective force output by the command of the terminal to obtain the resultant force on each degree of freedom;

a conversion module configured to distribute the resultant forces in the fusion module to various thrusters of the unmanned underwater vehicle based on a thrust distribution matrix, thus obtaining the output force of each thruster; and

an output module configured to fuse the output force of each thruster with the respective output force of the thruster output by the command of the terminal to obtain the thrust output required by the thruster.

As an improvement of the present disclosure, the closed-loop motion control system may further include a thrust saturation limiting function module, which is used to limit the output force of each thruster.

The present disclosure may provide the following beneficial effects. Compared with the related art, the present disclosure is aimed at systems with unsaturated degrees of freedom, and can automatically control the body balance and attitude stability based on the real-time attitude feedback of the unmanned underwater vehicle under the state of unsaturated degrees of freedom. Depending on the degrees of freedom having undergone dimensionality reduction, the present disclosure can determine the corresponding degrees of freedom depending on the number of PID controllers that can be activated and actual requirements, thus providing the thrusts required by the respective thrusters that are continuous and fed back in real time. Therefore, the present disclosure can fulfill the closed-loop motion control of the unmanned underwater vehicle in higher dimensional degrees of freedom in a very smooth and quick manner, resulting in high control stability and a control method that is easy to implement with simplicity and efficiency.

### BRIEF DESCRIPTION OF DRAWINGS

FIG. 1 is a flowchart illustrating a closed-loop motion control method for a three-thruster unmanned underwater vehicle according to the present disclosure.

FIG. 2 is a block diagram illustrating a closed-loop motion control system for a three-thruster unmanned underwater vehicle according to the present disclosure.

FIG. 3 is a flowchart illustrating a first embodiment of a closed-loop motion control method for a three-thruster unmanned underwater vehicle according to the present disclosure.

FIG. 4 is a flowchart illustrating the execution flow of the first embodiment of the closed-loop motion control method for a three-thruster unmanned underwater vehicle according to the present disclosure.

FIG. 5 is a schematic diagram illustrating the thrust distribution-mechanical model of the thrusters of the three-thruster unmanned underwater vehicle.

FIG. 6 is a schematic diagram illustrating the thrust distribution-control model of the thrusters of the three-thruster unmanned underwater vehicle.

### DETAILED DESCRIPTION

The present disclosure is aimed at a three-thruster unmanned underwater vehicle.

Based on the classic PID controller and combining the ordinary PID control schemes and integral separation and integral saturation principles, the present disclosure innovatively designs a closed-loop motion control strategy for an unsaturated degree of freedom system, which can automatically control the body balance and attitude stability depending on the real-time attitude feedback of the unmanned underwater vehicle under the state of unsaturated degrees of freedom.

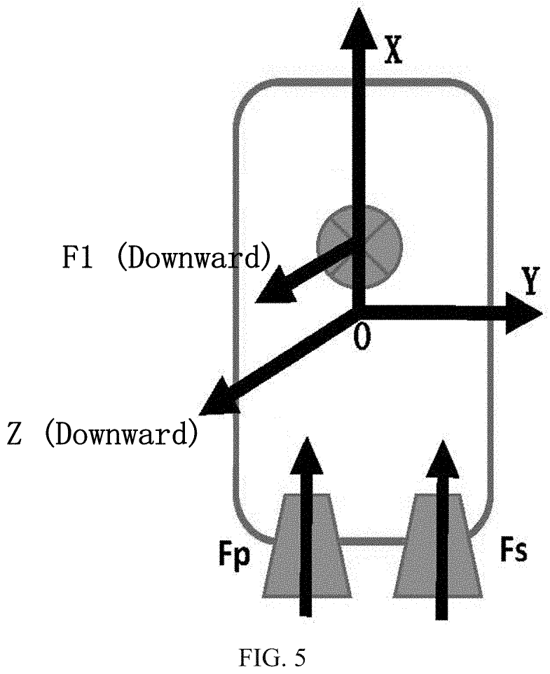

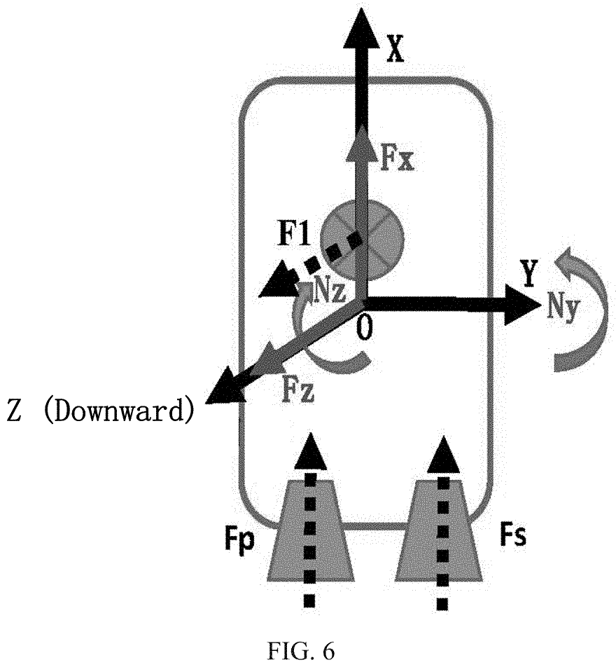

As illustrated in FIGS. 5 and 6, the three-thruster unmanned underwater vehicle uses a total of three thrusters as power units, including two horizontally oriented reversible thrusters are fitted in the tail part, one vertically oriented reversible thruster fitted in the middle part of the vehicle body. The three thrusters represent three directly controllable external forces acting on the main body of the three-thruster unmanned underwater vehicle in the mechanical model. Two are horizontal thrusts that are completely parallel to the plane of the main body, and one is a vertical thrust that is completely perpendicular to the plane of the main body.

The three-thruster mechanical model may be simplified into a rigid body structure subjected to three controllable external forces (thruster thrusts), without considering the impacts of ocean currents, surface winds and waves, and zero-buoyancy cables on the unmanned underwater vehicle.

As illustrated in FIG. 5, according to the arrangement of the thrusters of the three-thruster unmanned underwater vehicle, the mechanical model defines the condition of the main body underwater subjected to the action of the thrusts of three thrusters. In this model, we define the thrusts of the three thrusters as F1 (vertical thrust in the middle part of the vehicle body), Fp (horizontal left thrust at the tail) and Fs (horizontal right thrust at the tail). Under the action of the three different thrusts, the three-thruster unmanned underwater vehicle may be able to fulfill motion under different degrees of freedom. Depending on the arrangement and distribution characteristics of the thrusters, the main body can perform motion under the following four degrees of freedom, including:

1. Moving forward or backward along the X axis (surge);

2. Rising or diving along the Z axis (heave);

3. Changing the heading around the Z axis (yaw);

4. Changing the pitch angle around the Y axis (pitch).

As illustrated in FIG. 6, because the three-thruster unmanned underwater vehicle has no thrusters arranged along the Y axis and no thrusters arranged on both sides of the X axis, it is not able to perform the lateral translation (sway) along the Y axis and change the roll angle around the X axis (rolling). Corresponding to 4 degrees of freedom of motion, the three-thruster unmanned underwater vehicle is affected by 4 resultant forces on the 4 degrees of freedom respectively.

1. Fx denotes the resultant force the three-thruster unmanned underwater vehicle is subjected to along the X axis, which is used to move forward and backward;

2. Fz denotes the resultant force the three-thruster unmanned underwater vehicle is subjected to along the Z axis, which is used to rise and dive;

3. Nz denotes the torque of the three-thruster unmanned underwater vehicle around the Z axis, which is produced by the thrusts of the 2 tail horizontal thrusters and used to change the heading;

4. Ny denotes the torque of the three-thruster unmanned underwater vehicle around the Y axis, which is jointly produced by the 2 tail horizontal thrusts and one middle vertical thrust to adjust the pitch angle of the Titan body (body pitch).

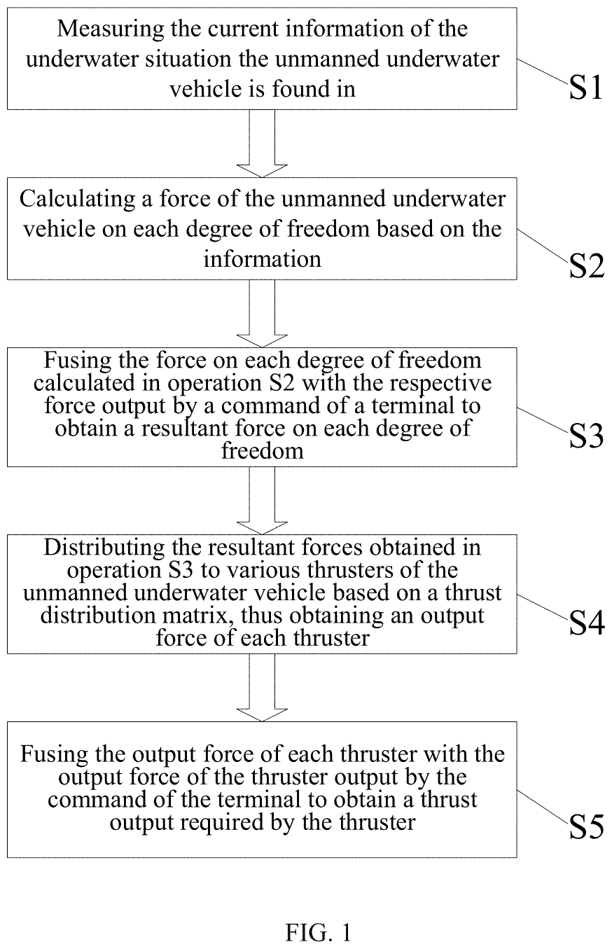

Referring to FIGS. 1 to 4, the present disclosure provides a closed-loop motion control method for a three-thruster unmanned underwater vehicle, which includes the following operations:

operation S1: measuring the current information of the underwater situation the unmanned underwater vehicle is found in;

operation S2: calculating the force of the unmanned underwater vehicle on each degree of freedom based on the information;

operation S3: fusing the force on each degree of freedom calculated in operation S2 with the respective force output by the command of the terminal to obtain the resultant force on each degree of freedom;

operation S4: distributing the resultant forces in operation S3 to various thrusters of the unmanned underwater vehicle based on a thrust distribution matrix, thus obtaining the output force of each thruster; and

operation S5: fusing the output force of each thruster with the respective output force of the thruster output by the command of the terminal to obtain the thrust output required by the thruster.

Compared with the related art, the present disclosure is aimed at systems with unsaturated degrees of freedom, and can automatically control the body balance and attitude stability based on the real-time attitude feedback of the unmanned underwater vehicle under the state of unsaturated degrees of freedom. Depending on the degrees of freedom that have undergone dimensionality reduction, the present disclosure can determine the corresponding degrees of freedom depending on the number of PID controllers that can be activated and actual requirements, thus providing the thrusts required by the respective thrusters that are continuous and fed back in real time. Therefore, the present disclosure can fulfill the closed-loop motion control of the unmanned underwater vehicle in higher dimensional degrees of freedom in a very smooth and quick manner, resulting in high control stability and a control method that is easy to implement with simplicity and efficiency.

Further included in the present disclosure is operation S6, including limiting the output force of each thruster. In particular, when the output force of the thruster exceeds a set value, the output force of the thruster is determined as the set value, for the purpose of restricting the thrust.

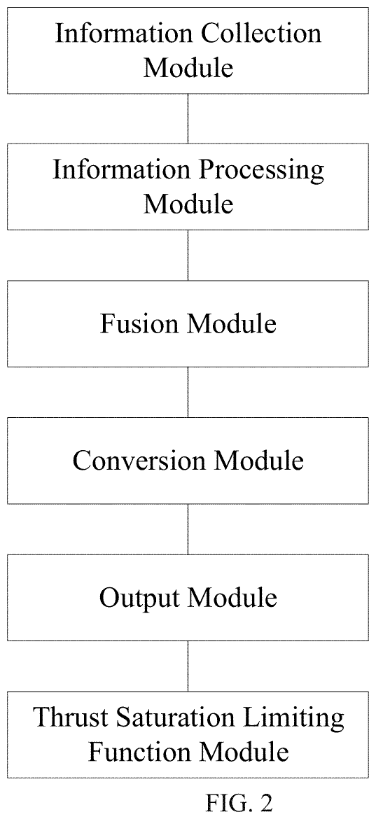

Referring now to FIG. 2, the present disclosure further provides a closed-loop motion control system for a three-thruster unmanned underwater vehicle, which includes:

an information collection module configured to measure the current information of the underwater situation the unmanned underwater vehicle is found in;

an information processing module configured to calculate the force of the unmanned underwater vehicle on each degree of freedom based on the information;

a fusion module configured to fuse the force on each degree of freedom calculated by the information processing module with the respective force output by the command of the terminal to obtain the resultant force on each degree of freedom;

a conversion module configured to distribute the resultant forces in the fusion module to various thrusters of the unmanned underwater vehicle based on a thrust distribution matrix, thus obtaining the output force of each thruster; and

an output module configured to fuse the output force of each thruster with the respective output force of the thruster output by the command of the terminal to obtain the thrust output required by the thruster.

The present disclosure may further include a thrust saturation limiting function module used to limit the output force of each thruster. In particular, depending on the actual situation of the unmanned underwater vehicle, the thrust saturation limiting function module provides a thrust saturation limiting function for the thrusters (control the thrusters to restrict their outputs), so that when the required thrust output exceeds the specified range, it would be limited to the maximum thrust.

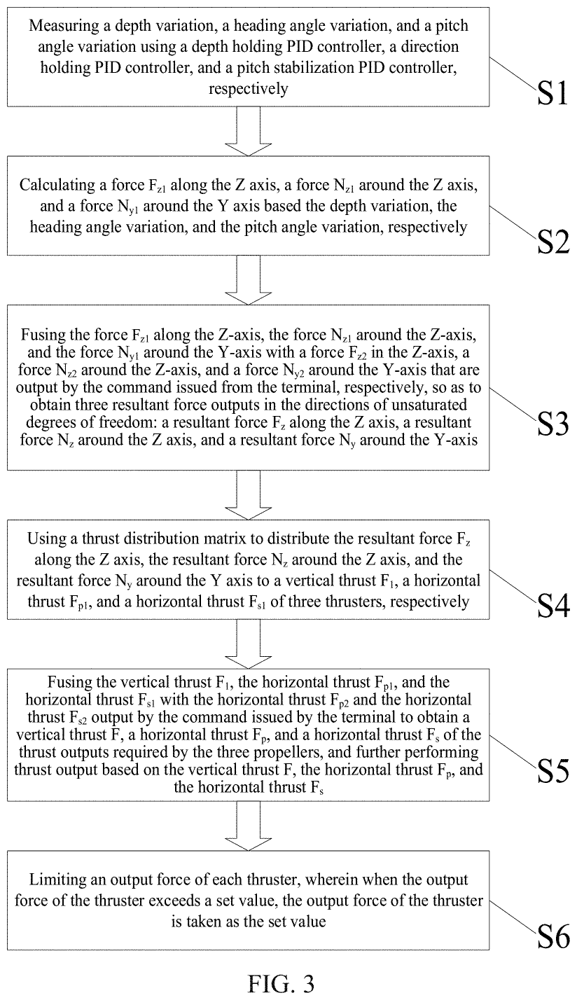

Referring now to FIG. 3, which illustrates a first embodiment of the closed-loop motion control system for a three-thruster unmanned underwater vehicle according to the present disclosure. The first embodiment may include the following operations:

operation S1: measuring a depth variation, a heading angle variation, and a pitch angle variation using a depth holding PID controller, a direction holding PID controller, and a pitch stabilization PID controller, respectively;

operation S2: calculating the force F_{z1} along the Z axis, the force N_{z1} around the Z axis, and the force N_{y1} around the Y axis based the depth variation, the heading angle variation, and the pitch angle variation, respectively;

operation S3: fusing the force F_{z1} along the Z-axis, the force N_{z1} around the Z-axis, and the force N_{y1} around the Y-axis with the force F_{z2} in the Z-axis, the force N_{z2} around the Z-axis, and the force N_{y2} around the Y-axis that are output by the command issued from the terminal, respectively, so as to obtain three resultant force outputs in the directions of unsaturated degrees of freedom: the resultant force F_{z} along the Z axis, the resultant force N_{z} around the Z axis, and the resultant force N_{y} around the Y-axis;

operation S4: using the thrust distribution matrix to distribute the resultant force F_{z} along the Z axis, the resultant force N_{z} around the Z axis and the resultant force N_{y} around the Y axis to the vertical thrust F₁, horizontal thrust Fₚ₁, and horizontal thrust Fₛ₁ of the three thrusters, respectively;

operation S5 includes: fusing the vertical thrust F₁, the horizontal thrust Fₚ₁, and the horizontal thrust Fₛ₁ with the horizontal thrust Fₚ₂ and the horizontal thrust Fₛ₂ output by the command issued by the terminal to obtain the vertical thrust F, horizontal thrust Fₚ, and horizontal thrust Fₛ of the thrust outputs required by the three thrusters, and further performing thrust output based on the vertical thrust F, the horizontal thrust Fₚ, and the horizontal thrust Fₛ; and

operation S6: limiting the output force of each thruster, where in particular, when the output force of the thruster exceeds a set value, the output force of the thruster is determined as the set value, for the purpose of restricting the thrust.

In operation S5, the vertical thrust F may be equal to the vertical thrust F₁, the horizontal thrust Fₚ may be equal to the sum of the horizontal thrust Fₚ₁ and the horizontal thrust Fₚ₂, and the horizontal thrust Fₛ may be equal to sum of the horizontal thrust Fₛ₁ and the horizontal thrust Fₛ₂.

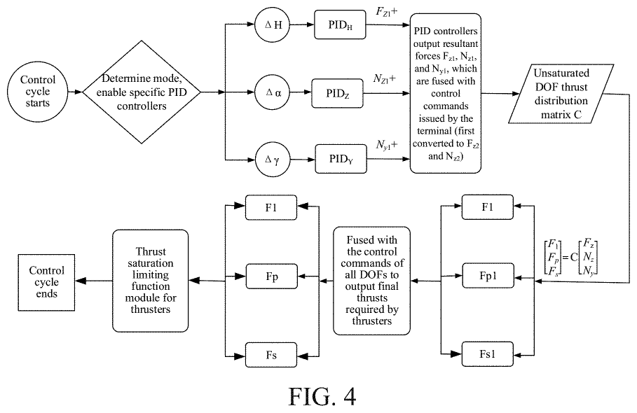

As illustrated in FIG. 4, according to the basic principles of mechanics, there is a conversion relationship between the control model of the three-thruster unmanned underwater vehicle and the initial three-thrust mechanical model. In particular, the three-thrust mechanical model can be converted into a 4-degree-of-freedom control model through a specific control matrix B, thereby facilitating subsequent PID control. For this unsaturated DOF system (the number of 4 DOFs is greater than the number of 3 thrusters), the conversion of 4 resultant forces into 3 thrusts of the thrusters will cause the subsequent matrix operations to be singular and impossible to invert, and so the DOF dimensions need to be reduced to 3. According to the three motion control parameters that the unmanned underwater vehicle can measure: depth, heading angle, and pitch angle, the three degrees of freedom after dimensionality reduction may be determined as: heave, roll and pitch, corresponding to three resultant forces Fz, Nz, and Ny. Therefore, the conversion between the mechanical model and the control model is:

$$B [ \begin{matrix}{F}_{1} \\ {F}_{p} \\ {F}_{s}\end{matrix} ] = [ \begin{matrix}{F}_{z} \\ {N}_{z} \\ {N}_{y}\end{matrix} ]$$

For a more accurate and decoupled motion control of the three-thrust underwater robot, the conversion matrix B can be used to solve for its pseudo-inverse matrix C, and the resultant forces in the three directions after dimensionality reduction can be used to inversely solve for the output thrusts of the three thrusters, where this pseudo-inverse matrix C is the thrust distribution matrix:

$$[ \begin{matrix}{F}_{1} \\ {F}_{p} \\ {F}_{s}\end{matrix} ] = C [ \begin{matrix}{F}_{z} \\ {N}_{z} \\ {N}_{y}\end{matrix} ]$$

According to the requirements of underwater unmanned underwater vehicle (UUV) engineering and the principle of practicability, the design of PID closed-loop automatic feedback control should also follow the principle of practicality. In the control model, the three-thruster unmanned underwater vehicle can fulfill motion in 3 degrees of freedom, and an independent PID controller that is not correlated with others needs to be designed corresponding to each degree of freedom, thereby trying to avoid the need of setting up a complex overall PID controller that need to consider multiple degrees of freedom. These PID controllers may include the following.

1. Depth holding PID controller: PIDH, where based on the depth signal of a depth sensor, the depth variation ΔH feedback is used to control the resultant force F_{z} in the Z-axis direction (depth). PIDH is a commonly used and indispensable controller.

2. Direction holding PID: PID_{Z}, where based on the heading angle measured by the magnetic compass, the heading angle variation Δα feedback is used to control the torque N_{z} around the Z axis. PID_{Z} is a commonly used PID controller.

3. Pitch stabilization PID: PID_{y}, where based on the pitch angle of the nine-axis sensor, the pitch angle variation Δγ feedback is used to control the torque N_{y} around the Y axis.

A typical PID controller may include a proportional parameter K_p, an integral parameter K_i, and a derivative parameter K_d. Regarding the PID controller design, the feedback signals are typically displacements such as depth, heading angle, bearing angle, and the resultant forces in the controlled 5 degrees of freedom have a linear relationship with the linear acceleration, angular acceleration, etc., so the proportional parameter K_p and the integral parameter K_i play a key role. Accordingly, structural design of the PID controller should be mainly based on PI, while the derivative parameter K_d plays a limited role. The design of the controller mainly considers the use of common PID combined with the concept of integral separation (that is, when the deviation between the controlled variable and the set value is relatively large, the integral action may be cancelled thus reducing the excessive feedback control caused by the large static error. When the controlled variable is close to the set value, integral control is introduced to eliminate static error thus improving the control precision.) for purposes of controlling the PID.

The present disclosure is mainly aimed at the “unsaturated DOFs PID control system”, that is, based on the degrees of freedom having undergone dimensionality reduction, this PID control system can determine the corresponding degrees of freedom according to the number of PID controllers that can be activated and the actual needs. Within a control cycle, all PID controllers will complete the calculation, and then determine the mode of the machine according to the control instruction, and call and combine different PID controllers to form a control system, regardless of whether a specific PID controller will be used.

The resultant force outputs F_{z1}, N_{z1}, and N_{y1} calculated by the respective PID controllers, corresponding to unsaturated degrees of freedom in three directions, namely along the Z axis, around the Z axis, and around the Y axis, are fused with the command outputs F_{z2}, N_{z2}, and N_{y2} given by the terminal (when N_{y2}=0, the terminal cannot provide control over the pitch torque N_{y2}). After fusion, three resultant force outputs in the directions of unsaturated degrees of freedom are finally obtained: F_{z}=F_{z1}+F_{z2}, N_{z}=N_{z1}+N_{z2}, and N_{y}=N_{y1}+N_{y2}. After calculating the final resultant forces on the unsaturated degrees of freedom, the resultant forces obtained from fusion are distributed to the thrusts F₁, Fₚ₁, and Fₛ₁ of the respective thrusters through the thrust distribution matrix and are finally fused with the command outputs Fₚ₂ and Fₛ₂ given by the terminal to obtain the final thrust outputs required by the respective thruster, including F₁=F₁, Fₚ=Fₚ₁+Fₚ₂, and Fₛ=Fₛ₁+Fₛ₂. Depending on the actual situation of the unmanned vehicle, a thrust saturation limiting function is provided for the thrusters (control the thrusters to restrict their outputs), so that when the required thrust output exceeds the specified range, it would be limited to the maximum thrust.

The present disclosure can automatically control the body balance and the attitude stability based on the real-time attitude feedback of the underwater vehicle under the state of unsaturated degrees of freedom. Furthermore, depending on the degrees of freedom having undergone dimensionality reduction, the corresponding degrees of freedom can be determined according to the number of PID controllers that can be activated and actual needs. Within a control cycle, all PID controllers will complete the calculation, and then determine the mode of the machine according to the control instruction, and call and combine different PID controllers, regardless of whether a specific PID controller will be used.

Depending on the degrees of freedom that have undergone dimensionality reduction, the present disclosure can provide the thrusts the 3 respective thrusters need to output that are continuous and fed back in real time. Therefore, the present disclosure can fulfill the closed-loop motion control of the unmanned underwater vehicle in higher dimensional degrees of freedom in a very smooth and quick manner, resulting in a control system with high stability and a control method that is easy to implement with simplicity and efficiency.

The foregoing merely illustrates some embodiments according to the present disclosure, and is not intended to limit the scope of the present disclosure. Any equivalent structural or flow transformation made by using the content of the description and drawings of the present disclosure, or direct or indirect application on other related technical fields shall all fall in the scope of patent protection of the present disclosure.

What is claimed is:

1. A closed-loop motion control method for a three-thruster unmanned underwater vehicle (UUV), comprising:
measuring current information of underwater situation the unmanned underwater vehicle is found in;
calculating a force of the unmanned underwater vehicle on each degree of freedom (DOF) based on the information;
fusing the force on each DOF calculated above with a respective force output by a command of a terminal to obtain a resultant force on each DOF;
distributing the resultant forces obtained above to a plurality of thrusters of the UUV based on a thrust distribution matrix, thus obtaining an output force of each of the plurality of thrusters; and
fusing the output force of each of the plurality of thrusters with the output force of the thruster that is output by the command of the terminal to obtain a thrust output required by the thruster.

2. The closed-loop motion control method as recited in claim 1, further comprising: limiting an output force of each of the plurality of thrusters, wherein when the output force of the thruster exceeds a set value, the output force of the thruster is taken as the set value.

3. The closed-loop motion control method as recited in claim 2, wherein the operation of “measuring current information of underwater situation the unmanned underwater vehicle is found in” comprises: measuring a depth variation, a heading angle variation, and a pitch angle variation using a depth holding PID controller, a direction holding PID controller, and a pitch stabilization PID controller, respectively.

4. The closed-loop motion control method as recited in claim 3, wherein the operation of “calculating a force of the unmanned underwater vehicle on each DOF based on the information” comprises: calculating a force F_{z1} along the Z axis, a force N_{z1} around the Z axis, and a force N_{y1} around the Y axis based the depth variation, the heading angle variation, and the pitch angle variation, respectively.

5. The closed-loop motion control method as recited in claim 4, wherein the operation of “fusing the force on each DOF calculated above with a respective force output by a command of a terminal to obtain a resultant force on each DOF” comprises: fusing the force F_{z1} along the Z-axis, the force N_{z1} around the Z-axis, and the force N_{y1} around the Y-axis with a force F_{z2} along the Z-axis, a force N_{z2} around the Z-axis, and a force N_{y2} around the Y-axis that are output by the command issued from the terminal, respectively, so as to obtain the following three resultant force outputs in the directions of unsaturated degrees of freedom: a resultant force F_{z} along the Z axis, a resultant force N_{z} around the Z axis, and a resultant force N_{y} around the Y-axis.

6. The closed-loop motion control method as recited in claim 5, wherein the operation of “distributing the resultant forces obtained above to a plurality of thrusters of the UUV based on a thrust distribution matrix, thus obtaining an output force of each of the plurality of thrusters” comprises: using a thrust distribution matrix to distribute the resultant force F_{z} along the Z axis, the resultant force N_{z} around the Z axis, and the resultant force N_{y} around the Y axis to a vertical thrust F₁, a horizontal thrust Fₚ₁, and a horizontal thrust Fₛ₁ of three thrusters, respectively.

7. The closed-loop motion control method as recited in claim 6, wherein the three thrusters comprise two horizontally oriented reversible thrusters that are fitted in a tail part of a vehicle body of the three-thruster UUV, and one vertically oriented reversible thruster fitted in a middle part of the vehicle body of the three-thruster UUV.

8. The closed-loop motion control method as recited in claim 6, wherein the operation of “fusing the output force of each of the plurality of thrusters with the output force of the thruster that is output by the command of the terminal to obtain a thrust output required by the thruster” comprises: fusing the vertical thrust F₁, the horizontal thrust Fₚ₁, and the horizontal thrust Fₛ₁ with the horizontal thrust Fₚ₂ and the horizontal thrust Fₛ₂ output by the command issued by the terminal to obtain a vertical thrust F, a horizontal thrust Fₚ, and a horizontal thrust Fₛ of the thrust outputs required by the three thrusters, and further performing thrust output based on the vertical thrust F, the horizontal thrust Fₚ, and the horizontal thrust Fₛ.

9. The closed-loop motion control method as recited in claim 8, wherein in the operation of “fusing the output force of each of the plurality of thrusters with the output force of the thruster that is output by the command of the terminal to obtain a thrust output required by the thruster”, the vertical thrust F is equal to the vertical thrust F₁, the horizontal thrust Fₚ is equal to the sum of the horizontal thrust Fₚ₁ and the horizontal thrust Fₚ₂, and the horizontal thrust Fₛ is equal to sum of the horizontal thrust Fₛ₁ and the horizontal thrust Fₛ₂.

10. A closed-loop motion control system for a three-thruster unmanned underwater vehicle, comprising:
an information collection module, configured to measure current information of underwater situation the unmanned underwater vehicle is found in;
an information processing module, configured to calculate a force of the unmanned underwater vehicle on each degree of freedom (DOF) based on the information;
a fusion module, configured to fuse the force on each DOF calculated by the information processing module with a respective force output by a command of a terminal to obtain a resultant force on each DOF;
a conversion module, configured to distribute the resultant forces in the fusion module to a plurality of thrusters of the unmanned underwater vehicle based on a thrust distribution matrix, thus obtaining the output force of each of the plurality of thrusters; and
an output module, configured to fuse the output force of each of the plurality of thrusters with the output force of the thruster output by the command of the terminal to obtain the thrust output required by the thruster.

11. The closed-loop motion control system as recited in claim 10, further comprising a thrust saturation limiting function module configured to limit an output force of each of the plurality of thrusters.

12. The closed-loop motion control system as recited in claim 10, wherein the information collection module is configured to measure the current information of the underwater situation of the UUV is found in by:
measuring a depth variation, a heading angle variation, and a pitch angle variation using a depth holding PID controller, a direction holding PID controller, and a pitch stabilization PID controller, respectively.

13. The closed-loop motion control system as recited in claim 12, wherein the information processing module is configured to calculate the force of the UUV on each DOF based on the information by:
calculating a force F_{z1} along the Z axis, a force N_{z1} around the Z axis, and a force N_{y1} around the Y axis based the depth variation, the heading angle variation, and the pitch angle variation, respectively.

14. The closed-loop motion control system as recited in claim 13, wherein the fusion module is configured to fuse the force on each DOF calculated by the information processing module with the respective force output by the command of the terminal to obtain a resultant force on each DOF by:
fusing the force F_{z1} along the Z-axis, the force N_{z1} around the Z-axis, and the force N_{y1} around the Y-axis with a force F_{z2} along the Z-axis, a force N_{z2} around the Z-axis, and a force N_{y2} around the Y-axis that are output by the command issued from the terminal, respectively, so as to obtain the following three resultant force outputs in the directions of unsaturated degrees of freedom: a resultant force F_{z} along the Z axis, a resultant force N_{z} around the Z axis, and a resultant force N_{y} around the Y-axis.

15. The closed-loop motion control system as recited in claim 14, wherein the conversion module is configured to distribute the resultant forces in the fusion module to a plurality of thrusters of the unmanned underwater vehicle based on a thrust distribution matrix, thus obtaining the output force of each of the plurality of thrusters by:
using a thrust distribution matrix to distribute the resultant force F_{z} along the Z axis, the resultant force N_{z} around the Z axis, and the resultant force N_{y} around the Y axis to a vertical thrust F₁, a horizontal thrust Fₚ₁, and a horizontal thrust Fₛ₁ of three thrusters, respectively.

16. The closed-loop motion control system as recited in claim 15, wherein the three thrusters comprise two horizontally oriented reversible thrusters that are fitted in a tail part of a vehicle body of the three-thruster UUV, and one vertically oriented reversible thruster fitted in a middle part of the vehicle body of the three-thruster UUV.

17. The closed-loop motion control system as recited in claim 15, wherein the output module is configured to fuse the output force of each of the plurality of thrusters with the output force of the thruster output by the command of the terminal to obtain the thrust output required by the thruster by:
fusing the vertical thrust F₁, the horizontal thrust Fₚ₁, and the horizontal thrust Fₛ₁ with the horizontal thrust Fₚ₂ and the horizontal thrust Fₛ₂ output by the command issued by the terminal to obtain a vertical thrust F, a horizontal thrust Fₚ, and a horizontal thrust Fₛ of the thrust outputs required by the three thrusters, and further performing thrust output based on the vertical thrust F, the horizontal thrust Fₚ, and the horizontal thrust Fₛ.

18. The closed-loop motion control system as recited in claim 17, wherein the vertical thrust F is equal to the vertical thrust F₁, the horizontal thrust Fₚ is equal to the sum of the horizontal thrust Fₚ₁ and the horizontal thrust Fₚ₂, and the horizontal thrust Fₛ is equal to sum of the horizontal thrust Fₛ₁ and the horizontal thrust Fₛ₂.
